(19) United States
(12) Patent Application Publication
(10) Pub. No.: US 2024/0196180 A1
(43) Pub. Date: Jun. 13, 2024

(54) First Node, Second Node, Communications System and Methods Performed Thereby for Handling One or More Data Sessions

(71) Applicant: Telefonaktiebolaget LM Ericsson (publ), Stockholm (SE)

(72) Inventors: Miguel Angel Muñoz De La Torre Alonso, Madrid (ES); Rodrigo Alvarez Dominguez, Madrid (ES); Emiliano Merino Vazquez, Madrid (ES)

(21) Appl. No.: 18/285,015

(22) PCT Filed: Apr. 26, 2021
(86) PCT No.: PCT/EP2021/060838

§ 371 Date: Sep. 29, 2023

(30) Foreign Application Priority Data
Mar. 30, 2021 (EP) 21382262.0

(51) Int. Cl. H04W 4/90; H04W 8/02; H04W 48/04; H04W 48/06

(52) U.S. Cl. CPC H04W 4/90; H04W 8/02; H04W 48/04; H04W 48/06

(57) ABSTRACT

A computer-implemented method, performed by a first node (111), for handling one or more data sessions. The first node (111) operates in the communications system (100). The first node (111) receives (301) a first indication originating from an external node (113) operating outside the communications system (100). The first indication indicates a request to preclude one or more data sessions meeting one or more conditions indicated by the external node (113). The first node (111) also initiates (305) the preclusion of the one or more data sessions by sending another indication to a second node (112) operating in the communications system (100). The another indication indicates the received request.

### TECHNICAL FIELD

The present disclosure relates generally to a first node and methods performed thereby for handling one or more data sessions. The present disclosure also relates generally to a second node, and methods performed thereby for handling the one or more data sessions. The present disclosure further relates generally to a communications system and methods performed thereby for handling the one or more data sessions. The present disclosure also relates generally to computer programs and computer-readable storage mediums, having stored thereon the computer programs to carry out these methods.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the RAN, radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization 3GPP is currently in the process of specifying a New Radio Interface called NR or 5G-UTRA, as well as a Fifth Generation (5G) Packet Core Network, which may be referred to as 5G Core Network, abbreviated as 5GC.

A 3GPP system comprising a 5G Access Network (AN), a 5G Core Network and a UE may be referred to as a 5G system.

FIG. 1 is a schematic diagram depicting a particular example of a 5GC reference architecture as defined by 3GPP, which may be used as a reference for the present disclosure. An Application Function (AF) 1 may interact with the 3GPP Core Network through a Network Exposure Function (NEF) 2. Specifically in the context herein, the AF 1 may allow external parties to use the Exposure Application Program Interfaces (APIs) offered by the network operator. The NEF may support different functionality and specifically in the context of this document, the NEF may support different Exposure APIs. The Policy Control Function (PCF) 3 may include the following functionality: support unified policy framework to govern network behavior, provide policy rules to Control Plane function(s) to enforce them, and access subscription information relevant for policy decisions in a Unified Data Repository (UDR). A Network Repository Function (NRF) 4 may support registration and discovery procedures. The Session Management Function (SMF) 5 may support different functionality, e.g., Session Establishment, modify and release, and policy related functionalities such as termination of interfaces towards policy control functions, charging data collection, support of charging interfaces and control and coordination of charging data collection at the User Plane function (UPF) 6. Specifically, for the context of this document, the SMF 5 may receive Policy and Charging Control (PCC) rules from the PCF 3 and may configure the UPF 6 accordingly through the N4 reference point 7, in accordance with the Packet Flow Control Protocol (PFCP) protocol as follows. The SMF 5 may control the packet processing in the UPF 6 by establishing, modifying or deleting PFCP Sessions and by provisioning, e.g., adding, modifying or deleting, Packet Detection Rules (PDRs), Forwarding Action Rules (FARs), Quality of Service Enforcement Rules (QERs) and/or Usage Reporting Rules (URRs) per PFCP session, whereby a PFCP session may correspond to an individual Packet Data Unit (PDU) session or a standalone PFCP session not tied to any PDU session. Each PDR may contain Packet Detection Information (PDI) specifying the traffic filters or signatures against which incoming packets may be matched. Each PDR may be associated to the following rules providing the set of instructions to apply to packets matching the PDI. According to a first rule, one FAR, which may contain instructions related to the processing of the packets, may specifically forward, redirect, duplicate, drop or buffer the packet with or without notifying the Control Plane (CP) function about the arrival of a Downlink (DL) packet. According to a second rule, zero, one or more QERs, which may contain instructions related to the Quality of Service (QOS) enforcement of the traffic. According to a third rule, zero, one or more URRs, which may contain instructions related to traffic measurement and reporting. The UPF 6 may support handling of user plane traffic based on the rules received from the SMF 5, specifically for the context of this document, packet inspection, e.g., through PDRs, and different enforcement actions, such as traffic steering, QoS, Charging/Reporting, e.g., through FARs, QERs and URRs. A Policy Control Function (PCF) 3 may be understood to support a unified policy framework to govern the behavior of the network. The PCF 3 may provide Policy and Charging Control (PCC) rules to the Policy and Charging Enforcement Function (PCEF). The PCF 3 may provide policy rules to a user equipment (UE) 8 through the Access and Mobility Function (AMF) 9. The AMF 9 may manage access of the UE 8. For example, when the UE 8 may be connected through different access networks, and mobility aspects of the UE 8. Specifically, the AMF 9 may be used to forward UE rules from the PCF 3 to the UE 8. The UE 8 may be understood as a type of device. Devices within a communications network may be user equipments (UEs), e.g., stations (STAs), wireless devices, mobile terminals, wireless terminals, terminals, and/or Mobile Stations (MS). User equipments are enabled to communicate wirelessly in a cellular communications network or wireless communication network, sometimes also referred to as a cellular radio system, cellular system, or cellular network. The communication may be performed e.g., between two user equipments, between a user equipment and a regular telephone, and/or between a user equipment and a server via a Radio Access Network (RAN) 10, and possibly one or more core networks, comprised within the communications network. Devices may further be referred to as mobile telephones, cellular telephones, laptops, or tablets with wireless capability, just to mention some further examples. The devices in the present context may be, for example, portable, pocket-storable, hand-held, computer-comprised, or vehicle-mounted mobile devices, enabled to communicate voice and/or data, via the RAN 10, with another entity, such as another terminal or a server. Also depicted in FIG. 1 are a Network Slice Selection Function (NSSF) 11, a Unified Data Management (UDM) 12, an Authentication Server Function (AUSF) 13 and a Data Network (DN) 14. Each of the NSSF 11, the NEF 2, the NRF 4, the PCF 3, the UDM 12, the AF 1, the AUSF 13, the AMF 9 and the SMF 5 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23. Each of the UE 8, the RAN 10 and the UPF 6 may have an interface through which they may be accessed, which as depicted in the Figure, may be, respectively: N1 24, N2 25 and N4 7. The RAN 10 may have an interface N3 26 with the UPF 6. The UPF 6 may have an interface N6 27 with the DN 14.

Existing methods to handle emergency situations involving a communications network may be ineffective, or hinder the provision of services by the communications network.

### SUMMARY

In the event of an emergency, e.g. suspicion of terrorist attack, where the activation of the devices and/or bombs are usually performed using cellular networks, the police typically use frequency inhibitors or jammers. This has a number of problems. Communications are blocked beyond the target location, preventing users from accessing authorized communications services. Using jammers with poor quality filters and transmitters may generate harmful emissions outside the operating band, affecting radio services that operate in other bands. When jammers operate in multiple frequency bands, they may generate harmful interfering signals in other bands and affect all types of services. They may even obstruct the work of police by blocking law enforcement radio communications systems, due to a phenomenon known as intermodulation products. Further, blind spots may occur in the target location.

It is an object of embodiments herein to improve the handling of one or more data sessions in a communications system.

According to a first aspect of embodiments herein, the object is achieved by a computer-implemented method, performed by a first node. The method is for handling a data session. The first node operates in the communications system. The first node receives, a first indication originating from an external node operating outside the communications system. The first indication indicates a request to preclude one or more data sessions meeting one or more conditions indicated by the external node. The first node also initiates the preclusion of the one or more data sessions by sending another indication to a second node operating in the communications system. The another indication indicates the received request.

According to a second aspect of embodiments herein, the object is achieved by a computer-implemented method, performed by the second node. The method is for handling the data session. The second node operates in the communications system. The second node obtains, from another node operating in the communications system, an indication indicating the request to preclude the one or more data sessions meeting the one or more conditions. The request is according to an indicated service of the communications system. The second node also determines the one or more data sessions meeting the one or more conditions, thereby initiating the preclusion of the one or more data sessions.

According to a third aspect of embodiments herein, the object is achieved by a computer-implemented method, performed by a communications system. The communications system comprises the first node and the second node. The method is for handling the data session. The method comprises receiving, by the first node operating in the communications system, the first indication originating from the external node operating outside the communications system. The first indication indicates the request to preclude the one or more data sessions meeting the one or more conditions indicated by the external node. The method also comprises initiating, by the first node, the preclusion of the one or more data sessions by sending another indication to the second node operating in the communications system. The another indication indicates the received request. The method additionally comprises obtaining, by the second node, from another node operating in the communications system, the another indication indicating the request to preclude the one or more data sessions meeting the one or more conditions. The request is according to the indicated service of the communications system. The method further comprises determining, by the second node, the one or more data sessions meeting the one or more conditions, thereby initiating the preclusion of the one or more data sessions.

According to a fourth aspect of embodiments herein, the object is achieved by the first node, for handling the data session. The first node is configured to operate in the communications system. The first node is further configured to receive the first indication configured to originate from the external node configured to operate outside the communications system. The first indication is configured to indicate the request to preclude the one or more data sessions configured to meet the one or more conditions configured to be indicated by the external node. The first node is also configured to initiate the preclusion of the one or more data sessions by sending the another indication to the second node configured to operate in the communications system. The another indication is configured to indicate the request configured to be received.

According to a fifth aspect of embodiments herein, the object is achieved by the second node, for handling the data session. The second node is configured to operate in the communications system. The second node is further configured to obtain, from the another node configured to operate in the communications system, the indication configured to indicate the request to preclude the one or more data sessions meeting the one or more conditions. The request is configured to be according to the service of the communications system configured to be indicated. The second node is also configured to determine the one or more data sessions meeting the one or more conditions, thereby initiating the preclusion of the one or more data sessions.

According to a sixth aspect of embodiments herein, the object is achieved by the communications system, for handling the data session. The communications system comprises the first node and the second node. The communications system is configured to receive, by the first node configured to operate in the communications system, the first indication. The first indication is configured to originate from the external node configured to operate outside the communications system. The first indication is configured to indicate the request to preclude the one or more data sessions meeting the one or more conditions configured to be indicated by the external node. The communications system is also configured to initiate, by the first node, the preclusion of the one or more data sessions by sending the another indication to the second node configured to operate in the communications system. The another indication is configured to indicate the request configured to be received. The communications system is further configured to obtain, by the second node, from the another node configured to operate in the communications system, the another indication. The another indication is configured to indicate the request to preclude the one or more data sessions meeting the one or more conditions. The request is configured to be according to the service of the communications system configured to be indicated. The communications system is also configured to determine, by the second node, the one or more data sessions meeting the one or more conditions, thereby the communications system is configured to indicate the preclusion of the one or more data sessions.

According to a seventh aspect of embodiments herein, the object is achieved by a computer program, comprising instructions which, when executed on at least one processor, cause the at least one processor to carry out the method performed by the first node.

According to an eighth aspect of embodiments herein, the object is achieved by a computer-readable storage medium, having stored thereon the computer program, comprising instructions which, when executed on at least one processor, cause the at least one processor to carry out the method performed by the first node.

According to a ninth aspect of embodiments herein, the object is achieved by a computer program, comprising instructions which, when executed on at least one processor, cause the at least one processor to carry out the method performed by the second node.

According to a tenth aspect of embodiments herein, the object is achieved by a computer-readable storage medium, having stored thereon the computer program, comprising instructions which, when executed on at least one processor, cause the at least one processor to carry out the method performed by the second node.

By receiving the first indication, the first node may be enabled initiate preclusion of the one or more data sessions meeting the one or more conditions indicated by the external node. By sending the another indication to the second node, the second node may then be enabled to determine which data sessions may meet the one or more conditions, and initiate their preclusion. The first node may therefore allow that the external node, that is, an external party such as owners of IoT devices, government, police, etc., may request an operator of the communications system, via the first node, to terminate and/or block data sessions or services for certain users and/or devices matching certain conditions during a scheduled time period or permanently. The conditions may be for, example, abnormal behavior, location, type of device to be blocked, roaming users affected only, etc. . . . . This may in turn enable to provide support for different use cases, such as, for example, in the event of an emergency, e.g., a suspicion of terrorist attack, which may usually be performed using cellular networks. The police or government, via the external node, may be enabled to request to terminate and/or block the data sessions for all devices in a certain area or around a key person, e.g., the president or the head of state. This may be enabled while avoiding the use of frequency inhibitors or jammers. In another example use case, a city townhall may be enabled to request to terminate the data sessions for all streetlight IoT devices in a certain area, e.g., a city neighborhood, during a certain time. In yet another example, in the case of malfunctioning of a given type of device, e.g., 1M smart sensors causing a huge signalling increase due to a wrong firmware software update, the first node may enable to disconnect devices from the communications system automatically and immediately when the problem may be detected at the external node.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a flowchart depicting embodiments of a method in a communications system, according to embodiments herein.

FIG. 6 is a schematic diagram depicting a non-limiting example of signalling between nodes in a communications system, according to embodiments herein.

FIG. 7 is a schematic diagram depicting a continuation of FIG. 6.

FIG. 8 is a schematic diagram depicting another non-limiting example of signalling between nodes in a communications system, according to embodiments herein.

FIG. 9 is a schematic block diagram illustrating two non-limiting examples, a) and b), of a first node, according to embodiments herein.

FIG. 10 is a schematic block diagram illustrating two non-limiting examples, a) and b), of a second node, according to embodiments herein.

FIG. 11 is a schematic block diagram illustrating two non-limiting examples, a) and b), of a communications system, according to embodiments herein.

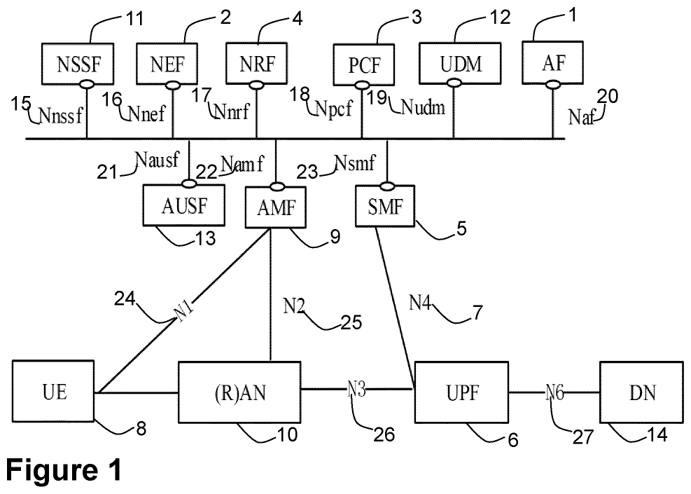

### DETAILED DESCRIPTION

Embodiments herein may be understood to relate to a mechanism which addresses the problems explained in the Summary section, and may be understood to be based on the definition of a new API, e.g., a new Nnef API, which may allow a node such as an AF, to request a Mobile Network Operator (MNO), e.g., through another node such as a NEF, to terminate already started PDU sessions, including Internet Protocol (IP) and/or non-IP connectivity, and to block new PDU sessions requested by certain users and/or devices under certain conditions, e.g., abnormal behavior, location, during a certain time period or permanently. Also described are mechanisms to allow a node, such as the AF, to request the MNO, e.g., through another node such as the NEF, to block a specific application or Quality of Service (QOS) flow, e.g., a service data flow, for the users and/or devices matching the conditions that may have been specified.

Particular embodiments herein may be understood to relate to AF requested PDU session termination.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

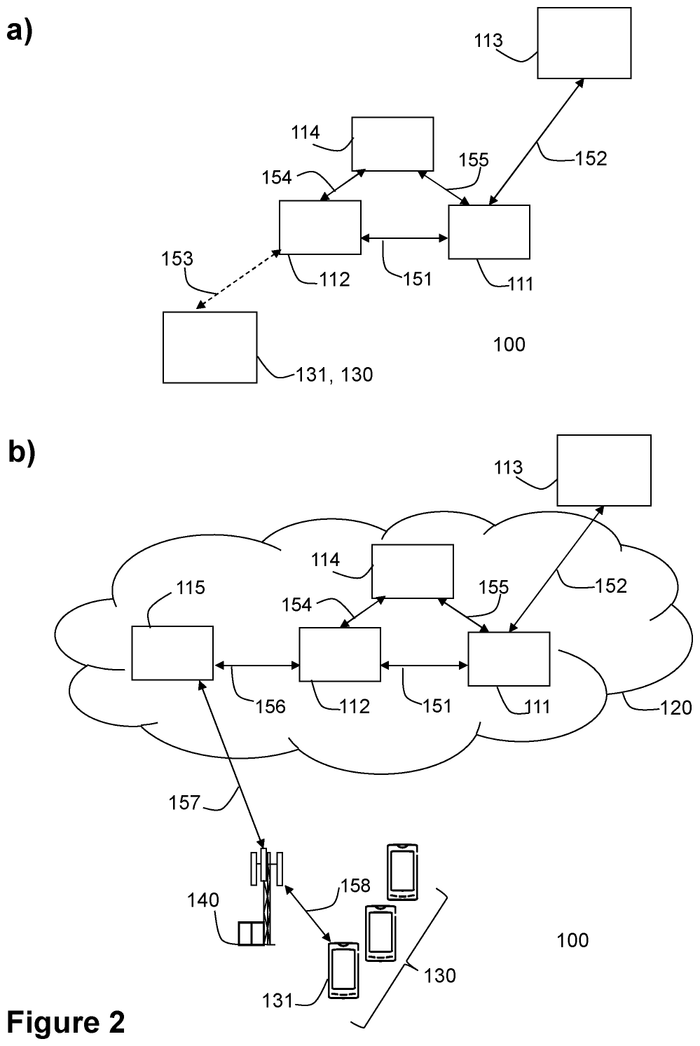

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IOT).

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

The communications system 100 may comprise a plurality of nodes, and/or operate in communication with other nodes. In FIG. 2, panel a) depicts a first node 111, a second node 112, a third node or external node 113, and a fourth node 114, which are all comprised in the communications system 100, with the exception of the external node 113. Any of the first node 111, the second node 112, the external node 113 and the fourth node 114 may be understood, respectively, as a first computer system, a second computer system, a third computer system and a fourth computer system. In some examples, any of the first node 111, the second node 112, the external node 113 and the fourth node 114 may be implemented as a standalone server in e.g., a host computer in the cloud 120, as depicted in the non-limiting example depicted in panel b) of FIG. 2. Any of the first node 111, the second node 112, the external node 113 and the fourth node 114 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the external node 113 and the fourth node 114 may also be implemented as processing resources in a server farm.

In some embodiments, any of the first node 111, the second node 112, the external node 113 and the fourth node 114 may be independent and separated nodes. In other embodiments, any of the first node 111, the second node 112, the external node 113 and the fourth node 114 may be co-located or be the same node. All the possible combinations are not depicted in FIG. 2 to simplify the Figure. In some embodiments, any of the first node 111 and the fourth node 114, may be referred to herein as the another node 111, 114.

It may be understood that the communications system 100 may comprise more nodes than those represented on panel a) of FIG. 2. In some examples, such as that depicted on panel b) of FIG. 2, the communications system 100 may comprise a fifth node 115. In other examples not depicted in FIG. 2, the communications system 100 may comprise a sixth node, and a seventh node. Any of the fifth node 115, the sixth node, and/or the seventh node may be understood to have a description equivalent to that provided above for the first node 111, the second node 112, the external node 113 or the fourth node 114.

In some examples of embodiments herein, the first node 111 may be a node having a capability to support different Exposure APIs. In some particular non-limiting examples, the first node 111 may be a NEF in 5G, a Service Capability Exposure Function (SCEF) in 4G, or a node capable of performing an equivalent function. The second node 112 may be a node having a capability to manage or control policies, such as a PCF in 5G, a Policy and Charging Rule Function (PCRF) in 4G, or a node capable of performing a similar function in the communications system 100. The external node 113 may be a node operating outside the communications system 100. The external node 113 may be understood to have a capability to allow external parties to use the Exposure Application Program Interfaces (APIs) offered by the network operator of the communications system 100, such as an AF in 5G, a Service Capability Server/Application Server (SCS/AS) in 4G, or a node or database capable of performing a similar function in the communications system 100. The fourth node 114 may be a node having a capability to store access subscription information relevant for policy decisions, and provide it on request. The fourth node 114 may be a UDR in 5G, a Subscriber Profile Repository (SPR) in 4G, a subscriber policy database, or a node capable of performing an equivalent function.

In the examples wherein the communications system 100 may comprise more nodes, the fifth node 115 may be a node having a capability to manage access of any of the one or more devices 130 to the communications system 100. The fifth node 115 may be, for example, a 5G AMF, or a node capable of performing an equivalent function.

The communications system 100 may comprise one or more devices 130 comprising at least a first device 131. Three devices are depicted in FIG. 2. However, it may be understood that fewer or more than three devices may be comprised in the one or more devices 130. Any of the one or more devices 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. Any of the one or more devices 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the one or more devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In some particular embodiments, any of the one or more devices 130 may be an Internet of Things (IOT) device, e.g., a NB IoT device.

The communications system 100 may comprise one or more radio network nodes, whereof a radio network node 140 is depicted in FIG. 2b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the external node 113 over a second link 152, e.g., a radio link or a wired link. The second node 112 may communicate, directly or indirectly, with any of the one or more devices 130 over a respective third link 153, e.g., a radio link or a wired link. The second node 112 may communicate, directly or indirectly with the fourth node 114 over a fourth link 154, e.g., a radio link or a wired link. The first node 111 may communicate with the fourth node 114 over a fifth link 155, e.g., a radio link or a wired link. The second node 112 may communicate, directly or indirectly with the fifth node 115 over a sixth link 156, e.g., a radio link or a wired link. The fifth node 115 may communicate, directly or indirectly with the radio network node 140 over a seventh link 157, e.g., a radio link or a wired link. The radio network node 140 may communicate with any of the one or more devices 130, e.g., the first device 131, over a respective eighth link 158, e.g., a radio link. Only one such link is depicted in FIG. 2 to simplify the figure. Any of the first link 151, the second link 152, the respective third link 153, the fourth link 154, the fifth link 155, the sixth link 156, the seventh link 157, and/or the respective eighth link 158 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns these adjectives modify.

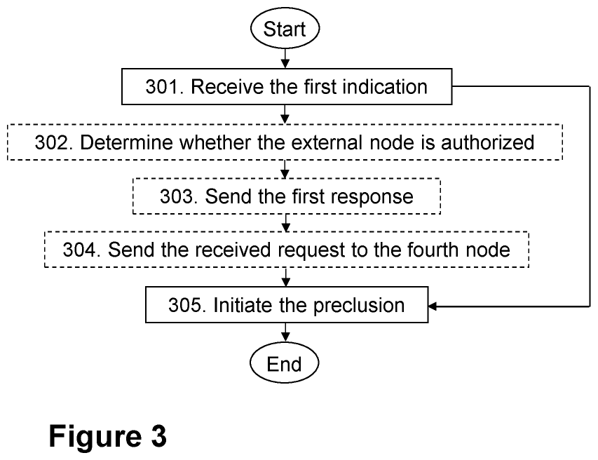

Embodiments of a computer-implemented method, performed by the first node 111, will now be described with reference to the flowchart depicted in FIG. 3. The method may be understood to be for handling one or more data sessions. The first node 111 operates in the communications system 100.

In some embodiments, the first node 111 may be a NEF.

The method may comprise the actions described below. In some embodiments all the actions may be performed. In some embodiments some of the actions may be performed. In FIG. 3, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

In FIG. 3, optional actions are represented with dashed boxes.

### Action 301

During the course of operations of the communications system 100, an emergency situation may arise, such as a suspicion of terrorist attack, where security forces may be interested in preventing that radio communications are used to perpetrate malicious acts, such as activation of devices and/or bombs. According to embodiments herein, an external node 113, such as for example, an AF operating in a network of the security forces, may request the first node 111, e.g., a NEF operating in the communications system 100, to terminate and/or block the data sessions, e.g., PDU sessions, for certain users and/or devices under certain conditions, such as in a certain location, during a certain time period or permanently.

According to the foregoing, in this Action 301, the first node 111 receives a first indication originating from the external node 113 operating outside the communications system 100. The first indication indicates a request to preclude one or more data sessions meeting one or more conditions indicated by the external node 113.

The one or more data sessions may be one or more PDU sessions.

The request to preclude may indicate at least one of: a) to terminate any ongoing data sessions of the one or more data sessions and b) to block any new data sessions of the one or more data sessions.

In some embodiments, the first node 111 may be a NEF and the external node 113 may be an AF. In some of such embodiments, the first indication may be, for example, a Nnef HTTP POST message, e.g., a Nnef_PDUSession/ServiceTermination request message triggered by the external node 113.

The receiving of the first indication may be performed e.g., via the second link 152.

The receiving of the first indication in this Action 301 may be after the first node 111 may have produced and/or exposed a new service announcing its capability to terminate and/or block data sessions on request, based for example on an authorization to do so. The new service may be, e.g., Nnef_PDUSession/ServiceTermination, for embodiments wherein the first node 111 may be a NEF, as a 5GC NF Service Producer.

In some embodiments, the first indication may indicate at least one of the following options. According to a first option, the first indication may indicate a first identifier of the external node 113. The first identifier may, for example, identify a police department, and/or a provider identifier, e.g., a ministry of regulatory services of a national government. The first identifier may be, for example, a parameter such as an AF-ID and/or a Provider-ID indicating the AF identifier. According to a second option, the first indication may indicate one or more respective second identifiers of the one or more devices 130 holding the ongoing data sessions to be terminated and/or to hold the new data sessions to be blocked, that is to hold new data sessions that may not have yet started, in a future time period. The one or more respective second identifiers may be one or more parameters indicating for example a list of users and/or devices, which may indicate the target users and/or devices, individually with a respective UE-ID, or as a group with a UE-Group-ID, or by a setting indicating that all of the devices are targets. For example, “AnyUE” may usually refer to “all UEs in the Public Land Mobile Network (PLMN). According to a third option, the first indication may indicate one or more second indications of the one or more conditions. The one or more second indications may comprise a parameter indicating a list of conditions of applicability relative to the list of users and/or devices above. For example, for a massive IoT scenario, the external node 113 may want to terminate and/or block data sessions for a specific Machine Type Communications (MTC) provider, or to terminate and/or block data sessions for devices in a certain location under suspicion, e.g., by the police or the government, of a terrorist attack in a certain area. According to a fourth option, the first indication may indicate a third indication of one or more applications the request may apply to. The third indication may be a parameter indicating a list of applications, e.g., a list of App-Identifiers (IDs). The third indication may be understood to allow the external node 113 to request termination and/or blocking of certain services within the data session. Following the example of a potential terrorist attack, e.g., the suspicion of a bomb, assuming the bomb may be activated remotely through an SMS message from a close by mobile terminal to the device attached to the bomb, the external node 113 may request to block SMS traffic, in which case this may be indicated as App-ID=SMS. According to a fifth option, the first indication may indicate a fourth indication of one or more flows the request may apply to. The fourth indication may be, e.g., a parameter indicating a list of QoS flows, such as service data flows. This may be understood to allow the external node 113 to request termination and/or blocking of certain services within a data session. According to a sixth option, the first indication may indicate a fifth indication of a time period during which the request may apply. That is, the fifth indication may indicate the scheduled time period, e.g. start time and stop time, during which the request from the external node 113 may apply, for example, start immediately and for a duration of 2 hours. The fifth indication may be, for example, the parameter TimePeriod. The absence of the fifth indication may indicate to permanently terminate and/or block the target data sessions and/or services. In this case, or when the external node 113 may want to cancel the previously scheduled procedure, a different indication, e.g., a Nnef_PDUSession/Service Termination Cancel request may be triggered by the external node 113.

Based on this, the one or more conditions may be indicated by at least one of the following options, although the list may be understood to be non-exhaustive. According to a first option, the one or more conditions may be indicated by a third identifier of a location wherein the request may apply, e.g., a geographical location which may be mapped by the first node 111 to a list of Tracking Area identities (TAIs) and/or Cell-IDs. The third identifier may be, for example, a “Location” parameter.

According to a second option, the one or more conditions may be indicated by a sixth indication of the first device 131 the location of which may determine a geographical area wherein the request may apply. As an alternative, or in addition, to the third identifier above, and to protect moving targets, such as key persons, e.g., a president or a head of state, the identity of the user and/or device for the key person may also be provided by the external node 113, e.g., by the police. In this case, all the devices around the device of the key person may be understood to be the ones to which data session termination and/or blockage may apply. The sixth indication may be for example, the parameter UE-ID. Both, the sixth indication, e.g., UE-ID of the device of the key person, and Radius, e.g. in meters, may be provided by the external node 113 as parameters.

According to a third option, the one or more conditions may be indicated by one or more respective seventh indications of the one or more data sessions. The one or more respective seventh indications may be understood to indicate ongoing and/or new data sessions, and may indicate to block either existing data sessions, new data sessions or both, which may be the default case.

According to a fourth option, the one or more conditions may be indicated by an eighth indication indicating whether or not the request may apply only to devices roaming in a network managed by the communications system 100, that is, whether or not the request from the external node 113 may only apply to inbound roamers.

According to a fifth option, the one or more conditions may be indicated by a ninth indication of a provider to which the request may apply, the provider being of at least a subset of the one or more devices 130. That is, the ninth indication may identify the provider for which the request from the external node 113 may apply to, so all devices from this provider may be understood to be the target of the request from the external node 113 to terminate and/or block data sessions. The provider may be e.g., an MTC provider. In such case, the ninth indication may be, e.g., an MTC provider name.

According to a sixth option, the one or more conditions may be indicated by a tenth indication of one or more types of devices the request may apply to. The tenth indication may identify the devices to which the request from the external node 113 may apply. The tenth indication may be, e.g., a Device type parameter, e.g., Type Allocation Code (TAC) in Permanent Equipment Identifier (PEI) or Subscription Permanent Identifier (SUPI)/International Mobile Subscriber Identity (IMSI) ranges. As an example, brand new devices may generate problems in the communications system 100, e.g., increase of signaling.

As another example, the tenth indication may indicate that the request from the external node 113 may apply only to devices with abnormal behavior. This may be used in networks with a node supporting detection of terminals with abnormal behavior in terms of mobile and/or communication pattern, e.g., a drone not following the expected track or moving into a forbidden area such as an airport. Such a node may be an NWDAF in a 5G network. In such examples, the tenth indication may be the parameter Devices with abnormal behavior.

According to a seventh option, the one or more conditions may be indicated by an eleventh indication of one or more types of RAT the request may apply to.

By receiving the first indication in this Action 301, the first node 111 may be enabled to preclude the one or more data sessions meeting one or more conditions indicated by the external node 113 and thereby allow the external node 113, that is, an external party such as owners of IoT devices, government, police, etc., to request the operator of the communications system 100 to terminate and/or block the data sessions or services for certain users and/or devices matching certain conditions, such as abnormal behavior, location, type of device to be blocked, roaming users affected only, etc, during a scheduled time period or permanently. This may in turn enable to support for different use cases, such as, for example, in the event of an emergency, e.g., a suspicion of terrorist attack, which may usually be performed using cellular networks, the police or government may be enabled to request to terminate and/or block the data sessions for all devices in a certain area or around a key person, e.g., the president or the head of state. This may be enabled while avoiding the use of frequency inhibitors or jammers. In another example use case, a city townhall may be enabled to request to terminate the data sessions for all streetlight IoT devices in a certain area, e.g., a city neighborhood, during a certain time. In yet another example, in the case of malfunctioning of a given type of device, e.g., 1M smart sensors causing a huge signalling increase due to a wrong firmware software update, performance of Action 301 may enable to disconnect device from the communications system 100 automatically and immediately when the problem may be detected at the external node 113, e.g., if the external node 113 is also acting as NWDAF.

### Action 302

In some embodiments, the first node 111, in this Action 302, may determine whether the external node 113 may be authorized for the received request.

Determining may be understood as e.g., calculating, deciding or detecting.

The determining in this Action 302 may comprise e.g., verifying the first identifier, e.g., AF-ID/Provider-ID, as the police or the government. For example, the verification may be performed on a per AF basis when the AF may be onboarded and certificates may have been exchanged between the AF and the first node 111, e.g., a NEF. Additionally, the first node 111 may need to verify if the external node 113, by checking the AF and/or Provider ID, may have sufficient rights for the requested operation. For example, it may be the case that the external node 113, identified with the AF and/or Provider ID, may not be allowed to tear down the data sessions for all UEs within a location permanently, but only for a configured and limited time. In this case, the request may be rejected. In summary, not only the external node 113 may need to be authorized, but also the proper combination of options and actions, e.g., a certain external node 113 may have rights to drop some IP flows, but not the entire data session.

A particular example of this Action 302 may comprise that a NEF authorizes a request from an AF.

By determining whether the external node 113 may be authorized for the received request in this Action 302, the first node 111 may ensure that the one or more data sessions are not precluded by unauthorized devices and/or nodes attempting to maliciously interfere with the operations of the communications system 100.

### Action 303

In this Action 303, the first node 111 may send a first response to the external node 113. The first response may indicate whether or not the request is authorized, that is, whether it may have been authorized or not by the first node 111 in Action 302. This may be understood to be based on a result of the determination performed in Action 302.

The sending of the first response may be performed e.g., via the second link 152.

### Action 304

In this Action 304, the first node 111 may send the received request to the fourth node 114 operating in the communications system 100, thereby requesting the fourth node 114 to store the received request.

This may be required e.g., to block new data sessions for target users and/or devices, or to block existing data sessions when the request from the external node 113 may be scheduled, and may not start immediately.

The sending of the first response may be performed e.g., via the fifth link 155.

The fourth node 114 may be a UDR. In some of such embodiments, the first node 111 may send, in this Action 304, a Nudr_Store Request to the fourth node 114.

### Action 305

In this Action 305, the first node 111, initiates the preclusion of the one or more data sessions by sending another indication to the second node 112 operating in the communications system 100. The another indication indicates the received request.

Initiating may be understood as triggering, enabling, starting or similar. That the first node 111 initiates sending may be understood to mean that the first node 111 may perform an action which may ultimately lead to the preclusion of the one or more data sessions.

The sending of the first response may be performed e.g., via the first link 151.

The sending of the another indication in this Action 305 may be based on the sent response in this Action 303.

In some embodiments, the first node 111 may be a NEF, the external node 113 may be an AF, and the second node 112 may be a PCF. In some examples, the initiating in this Action may comprise that the NEF discovers and forwards the AF request to the PCFs handling the sessions of a target user. The another indication may be a Npcf HTTPS POST message.

By the first node 111 initiating the preclusion of the one or more data sessions in this Action 305, the first node 111 may then enable the second node 112, e.g., the PCF, to trigger data session deactivation, and/or to block services within an existing data session, for the users and/or devices matching the requested conditions during the scheduled time period, or permanently. The first node 111 may additionally or alternatively enable the second node 112, e.g., the PCF, to block establishment of any new data session, or block services within a new data session, for the users and/or devices matching the requested conditions during the scheduled time period, or permanently.

At any point, a new indication may be received from the external node 113, cancelling the request originally sent, so that new data sessions for target users and/or devices matching the requested conditions, e.g. location, may now be allowed.

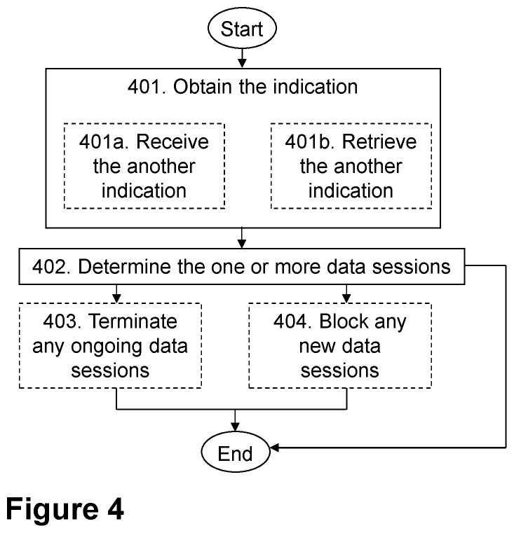

Embodiments of a computer-implemented method performed by the second node 112, will now be described with reference to the flowchart depicted in FIG. 4. The method may be understood to be for handling one or more data sessions. The second node 112 operates in the communications system 100.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some embodiments, the second node 112 may be a PCF.

### Action 401

In this Action 401, the second node 112 obtains, from another node 111, 114 operating in the communications system 100, an indication indicating the request to preclude the one or more data sessions meeting the one or more conditions. The request may be according to an indicated service of the communications system 100.

The indication may be understood to be, or correspond to, the another indication.

The service may be that announcing the capability of the first node 111 to terminate and/or block data sessions on request, based for example on an authorization to do so. The new service may be, e.g., Nnef_PDUSession/ServiceTermination, for embodiments wherein the first node 111 may be a NEF, as a 5GC NF Service Producer.

The obtaining 401 may comprise at least one of: a) receiving 401a the another indication from the first node 111 operating in the communications system 100, the another indication indicating the request to preclude the one or more data sessions meeting the one or more conditions, and b) retrieving 401b the another indication from the fourth node 114 operating in the communications system 100.

The receiving 401a, of the another indication may be performed e.g., via the first link 151. The retrieving 401b, of the another indication may be performed e.g., via the fifth link 155.

The request to preclude may indicate at least one of: a) to terminate any ongoing data sessions of the one or more data sessions, and b) to block any new data sessions of the one or more data sessions.

In some embodiments, the first indication may indicate at least one of the following: a) the first identifier of the external node 113, external to the communications system 100, from which the request to preclude may originate, b) the one or more respective second identifiers of the one or more devices 130 holding the ongoing data sessions to be terminated and/or to hold the new data sessions to be blocked, c) the one or more second indications of the one or more conditions, d) the third indication of one or more applications the request may apply to, e) the fourth indication of the one or more flows the request may apply to, and f) the fifth indication of the time period during which the request may apply.

The one or more conditions may be indicated by at least one of the following: a) the third identifier of the location wherein the request may apply, b) the sixth indication of the first device 131 the location of which may determine the geographical area wherein the request may apply, c) the one or more respective seventh indications of the one or more data sessions, d) the eighth indication indicating whether or not the request may apply only to devices roaming in the network managed by the communications system 100, e) the ninth indication of the provider to which the request may apply, the provider being of at least the subset of the one or more devices 130, f) the tenth indication of the one or more types of devices the request may apply to, and g) the eleventh indication of the one or more types of RAT the request may apply to.

In some embodiments, the second node 112, may be a PCF and the another node 111, 114 may be one of: a NEF, and a UDR.

### Action 402

In this Action 402, the second node 112 may determine the one or more data sessions meeting the one or more conditions, thereby initiating the preclusion of the one or more data sessions.

Determining may be understood as e.g., calculating, deciding or detecting.

In order to perform the determining in this Action 402, the second node 112 may subscribe to one or more events with the fifth node 115, and may receive one or more notifications in return. For example, the second node 112 may determine which data sessions may be affected by evaluating the conditions, e.g., the location. In this case, the second node 112 may subscribe to location, and location change, events for the target users and/or devices. This may be implemented with the existing location mechanisms defined by 3GPP. For example, the second node 112, as PCF, may trigger towards the fifth node 115, e.g., an AMF, a Namf_Event Exposure Subscribe Request message including the target event, e.g., Event-ID=Location, and the target user and/or device, e.g., UE-ID.

By the second node 112 determining the one or more data sessions meeting the one or more conditions, the second node 112 may be enabled to identify the one or more data sessions that may need to be terminated and/or blocked, and thereby enable that only the identified one or more sessions may be terminated and/or blocked, while others may remain unaffected. Thereby, security measures may be enforced while avoiding to unnecessarily impact other communications within the communications system 100 that represent no threat. The second node 112, after performing Action 402, may be enabled to perform at least one of the following two Actions.

### Action 403

In this Action 403, the second node 112 may terminate any ongoing data sessions of the determined one or more data sessions. For example, if the location retrieved in Action 402, e.g., Location Info, matches the target location indicated in the obtained indication, the second node 112 may trigger data session termination for ongoing sessions during the requested time period.

### Action 404

In this Action 404, the second node 112 may block any new data sessions of the determined one or more data sessions. For example, if the location retrieved in Action 402, e.g., Location Info, matches the target location indicated in the obtained indication, the second node 112 may block any new data sessions for target user and/or devices under the target location during the requested time period.

At any point, a new indication may be received from the first node 111, cancelling the request originally sent, so that new data sessions for target users and/or devices matching the requested conditions, e.g. location, may now be allowed.

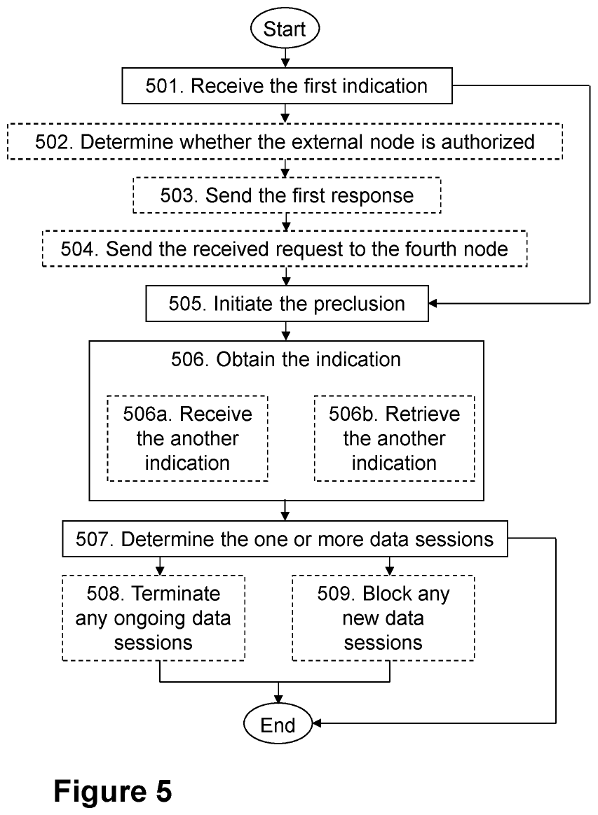

Embodiments of a computer-implemented method, performed by the communications system 100, will now be described with reference to the flowchart depicted in FIG. 5. The method may be understood to be for handling e one or more data sessions. The communications system 100 comprises the first node 111 and the second node 112.

The method may comprise the actions described below. In some embodiments some of the actions may be performed. In some embodiments all the actions may be performed. In FIG. 5, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of the Actions depicted in FIG. 5 may be understood to correspond to that already provided when describing the actions performed by each of the first node 111 and the second node 112, and will therefore not be repeated here. Any of the details and/or embodiments already described earlier may be understood to equally apply to the description below. For example, in some embodiments, the first node 111 may be a NEF, the external node 113 may be an AF, the second node 112 may be a PCF, and the another node 111, 114 may be one of: the first node 111, and a UDR.

### Action 501

This Action 501, which corresponds to Action 301, comprises, receiving, by the first node 111 operating in the communications system 100, the first indication originating from the external node 113 operating outside the communications system 100. The first indication indicates the request to preclude the one or more data sessions meeting the one or more conditions indicated by the external node 113.

To preclude may comprise at least one of: a) to terminate any ongoing data sessions of the one or more data sessions and b) to block any new data sessions of the one or more data sessions.

### Action 502

In some embodiments, the method may comprise, in this Action 502, which corresponds to Action 302, determining, by the first node 111, whether or not the external node 113 may be authorized for the received request.

### Action 503

In some embodiments, the method may comprise, in this Action 503, which corresponds to Action 303, sending, by the first node 111, the first response to the external node 113. The first response may indicate whether or not the request may be authorized.

### Action 504

In some embodiments, the method may comprise, in this Action 504, which corresponds to Action 304, sending, by the first node 111, the received request to the fourth node 114 operating in the communications system 100, thereby requesting the fourth node 114 to store the received request.

The fourth node 114 may be a UDR.

### Action 505

This Action 505, which corresponds to Action 305, comprises initiating, by the first node 111, the preclusion of the one or more data sessions by sending the another indication to the second node 112 operating in the communications system 100. The another indication indicates the received request. The sending of the another indication may be based on the sent response.

In some embodiments, at least one of the first indication and the another indication may indicate at least one of the following: a) the first identifier of the external node 113, external to the communications system 100, from which the request to preclude may originate, b) the one or more respective second identifiers of the one or more devices 130 holding the ongoing data sessions to be terminated and/or to hold the new data sessions to be blocked, c) the one or more second indications of the one or more conditions, d) the third indication of one or more applications the request may apply to, e) the fourth indication of the one or more flows the request may apply to, and f) the fifth indication of the time period during which the request may apply.

The one or more conditions may be indicated by at least one of the following: a) the third identifier of the location wherein the request may apply, b) the sixth indication of the first device 131 the location of which may determine the geographical area wherein the request may apply, c) the one or more respective seventh indications of the one or more data sessions, d) the eighth indication indicating whether or not the request may apply only to devices roaming in the network managed by the communications system 100, e) the ninth indication of the provider to which the request may apply, the provider being of at least the subset of the one or more devices 130, f) the tenth indication of the one or more types of devices the request may apply to, and g) the eleventh indication of the one or more types of RAT the request may apply to.

### Action 506

This Action 506, which corresponds to Action 401, comprises, obtaining, by the second node 112, from the another node 111, 114 operating in the communications system 100, the another indication indicating the request to preclude the one or more data sessions meeting the one or more conditions. The request is according to the indicated service of the communications system 100.

In some embodiments, the obtaining in this Action 506, 401 may comprise at least one of: a) receiving 506a, 401a, by the second node 112, the another indication from the first node 111 operating in the communications system 100, the another indication indicating the request to preclude the one or more data sessions meeting the one or more conditions, and b) retrieving 506b, 401b, by the second node 112, the another indication from the fourth node 114 operating in the communications system 100.

### Action 507

This Action 507, which corresponds to Action 402, comprises determining, by the second node 112, the one or more data sessions meeting the one or more conditions, thereby initiating the preclusion of the one or more data sessions.

### Action 508

In some embodiments, the method may comprise, in this Action 508, which corresponds to Action 403, terminating, by the second node 112, any ongoing data sessions of the determined one or more data sessions.

### Action 509

In some embodiments, the method may comprise, in this Action 509, which corresponds to Action 404, blocking, by the second node 112, any new data sessions of the determined one or more data sessions.

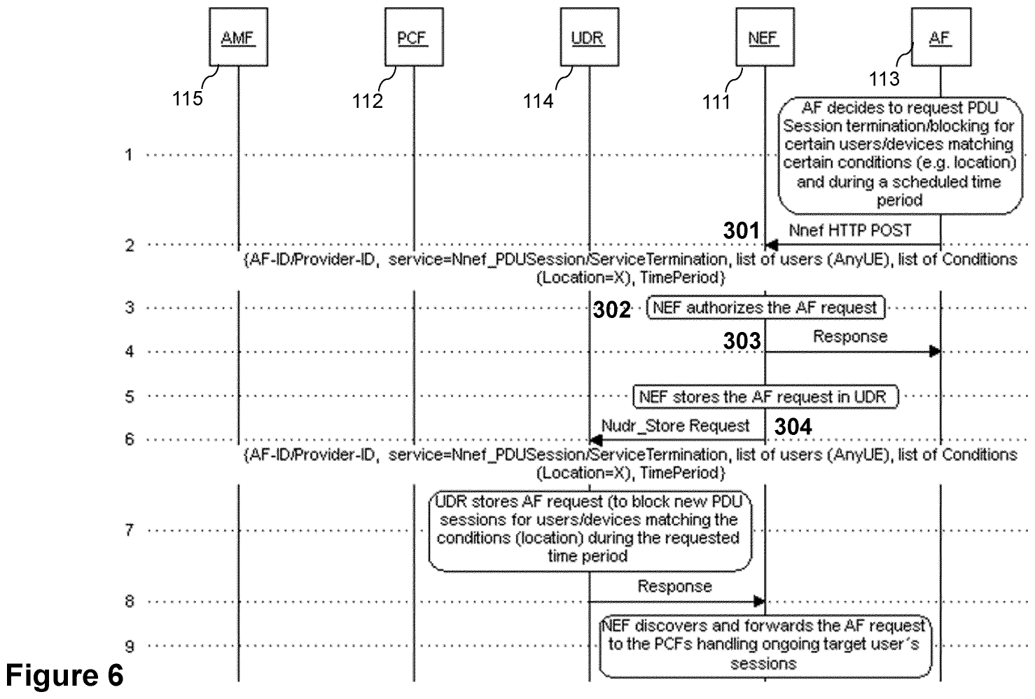

FIG. 6 is a signalling diagram depicting a first non-limiting example of embodiments herein illustrating a use case for a suspicion of a terrorist attack with a bomb. The steps of this example are detailed below. In this non-limiting example, the first node 111 is a NEF, the second node 112 is a PCF, the external node 113 is an AF, the fourth node 114 is a UDR. The communications system 100 also comprises a fifth node 115, which in this example is an AMF. In step 1, the external node 113, e.g., managed by the police suspecting a terrorist attack, decides to request a PDU Session termination for certain users and/or devices under a certain location and during a certain time period. In order to do this, the external node 113, in step 2, triggers the first indication as a Nnef_PDUSession/ServiceTermination, a HTTPS POST, request message including the following parameters: a) the first identifier as an AF-ID and/or Provider-ID, which indicates the AF identifier, e.g. identifies a police department, and/or Provider Identifier, e.g., national government for regulatory services; b) the one or more respective second identifiers of the one or more devices 130 as a list of users and/or devices, which determines the target users and/or devices, e.g., UE-ID, UE-Group-ID, AnyUE; in the sequence diagram example shown in FIG. 2, this is set to “AnyUE”; and optionally c) the one or more second indications of the one or more conditions as a list of conditions of applicability relative to the list of users and/or devices above. For example, “Any UE” may usually refer to “all UEs in the PLMN”, but for a massive IoT scenario, the external node 113 may want to terminate and/or block PDU sessions for a specific MTC provider, or the external node 113 may want to terminate and/or block PDU sessions for devices in a certain location, e.g., by the police or government suspecting a terrorist attack in a certain area. Based on this, the following conditions may be comprised, although the list may be understood be non-exhaustive: i) the third identifier as a Location parameter, which identifies the location where the external node 113 request applies, e.g., a geographical location which may be mapped by the first node 111 to a list of TAIs/Cell-IDs. In the sequence diagram example shown in FIG. 6, this is the only condition present, Location=X, where X may be a list of Cell-IDs; ii) as an alternative to the Location above, and to protect moving targets, such as key persons, e.g., the president or the head of state, the one or more respective second identifiers may also be provided by the external node 113, e.g., the police, as the identity of the user and/or device, e.g., UE-ID, for the key person. In this case, all the terminals around the terminal of the key person are the ones for which the PDU session termination and/or block applies to. In this case, both the UE-ID of the key person and the Radius, e.g. in meters, may be provided as parameters; iii) the fourth indication indicating the ongoing and/or new PDU sessions; this indicates to block either existing PDU sessions, new PDU sessions or both; iv) the eighth indication as a Roaming indication parameter, which indicates the external node 113 request only applies to inbound roamers; v) the ninth indication as an MTC provider name parameter, which identifies the MTC provider for which the external node 113 request applies, so all devices from this MTC provider are the target of the AF request to terminate and/or block PDU sessions; vi) the tenth indication as a Device type parameter, which identifies the devices to which the external node 113 request applies, e.g., TAC in PEI or SUPI/IMSI ranges; as an example, brand new devices may generate problems in the network, e.g., due to an increase of signalling; vii) another tenth indication as a Devices with abnormal behavior parameter, which indicates the external node 113 request applies only to devices with abnormal behavior. This may be used in networks with NWDAF supporting detection of terminals with abnormal behavior in terms of mobile and/or communication pattern, e.g., a drone moving into a forbidden area such as an airport; viii) optionally, the third indication as a list of applications parameter, e.g., App-IDs or the fourth indication as a QoS flows parameter indicating service data flows. This allows the external node 113 to request termination and/or blocking of certain services within the PDU session. Following the example of a potential terrorist attack, e.g., a suspicion of a bomb, assuming the bomb may be activated remotely through an SMS message from a close by mobile terminal to the device attached to the bomb, the external node 113 may request to block SMS, for example, by indicating that App-ID=SMS; ix) optionally, the fifth indication as a TimePeriod parameter, which indicates the scheduled time period, e.g., start time and stop time, for which the external node 113 request applies to, e.g., start immediately and for a duration of 2 hours. In case this parameter is not present, it may indicate to permanently terminate and/or block the target PDU sessions and/or services in this case, or when the external node 113 wants to cancel the previously scheduled procedure. According to Action 301, the first node 111 receives the first indication. In step 3, the first node 111, in accordance with Action 302, authorizes the external node 113 request, e.g., after verifying the AF-ID and/or Provider-ID as the police or the government. Additionally, the first node 111 needs to verify if the external node 113/Provider ID has sufficient rights for the requested operation, e.g., the external node 113/Provider-ID may not be allowed to tear down the PDU session for all UEs within a location permanently, but only for a configured and limited time. In this case, the request will be rejected. In summary, not only the external node 113 may need to be authorized, but also the proper combination of options and actions, e.g., a certain external node 113 may have rights to drop some IP flows, but not the entire PDU session. In step 4, in agreement with Action 303, the first node 111 triggers a response message to the external node 113 accepting the request. In steps 5 and 6, the first node 111 stores the external node 113 request in the fourth node 114 by sending, in agreement with Action 304, a Nudr_Store Request to the fourth node 114 in step 6. At step 7, the fourth node 114 stores the request from the external node 113 to block new PDU sessions for users and/or devices matching the conditions, e.g., location, during the requested time period. At step 8, the fourth node 114 triggers a response message to the first node 111 accepting the storage request. At step 9, the first node 111, in accordance with Action 305, discovers and forwards the external node 113 request to the second nodes 112 handling ongoing target user's sessions. In order to do this, the first node 111 performs step 10.

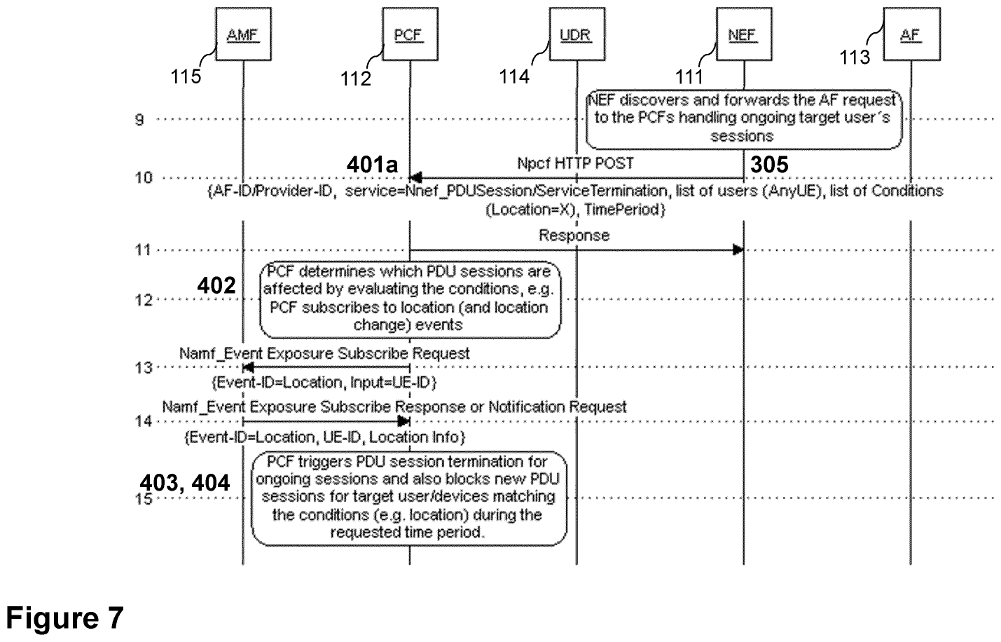

FIG. 7 is a continuation of the procedure depicted in FIG. 6. At step 10, the first node 111, in accordance with Action 305, triggers towards each discovered second node 112, a Npcf HTTPS POST message including the same parameters as in the message in step 2 above. In agreement with Action 401a, the second node 112 receives the another indication from the first node 111. At step 11, the second node 112 triggers a response message to the first node 111 accepting the storage request. At step 12, in agreement with Action 402, the second node 112 determines which PDU sessions are affected by evaluating the conditions, e.g., the location indicated by the external node 113. In this case, the second node 112, as part of Action 402, subscribes to location, and location change, events for the target users and/or devices. This may be performed according to the existing location mechanisms defined by 3GPP. For example, the second node 112 may be a PCF which, in step 13, may trigger towards an AMF a Namf_Event Exposure Subscribe Request message including the target event, e.g., Event-ID=Location, and the target user and/or device, e.g., UE-ID. At step 14, the fifth node 115 may answer to the second node 112 with a Namf_Event Exposure Subscribe Response or Notification Request message including the target event, e.g., Event-ID=Location, and the location, e.g., Location Info, for the UE-ID. At step 15, if the location retrieved in step above, that is, the Location Info, matches the target location originally indicated in Step 2, the second node 112 triggers, according to Action 403, a PDU session termination for ongoing sessions and also blocks, according to Action 404, any new PDU sessions for target user and/or devices under the target location during the requested time period. Not shown in the sequence diagram of FIG. 6, but in case the external node 113 wants to cancel the procedure, a Nnef_PDUSession/ServiceTermination Cancel request may be triggered by the external node 113, so new PDU sessions for target users/devices matching the requested conditions, e.g. location, may now be allowed.

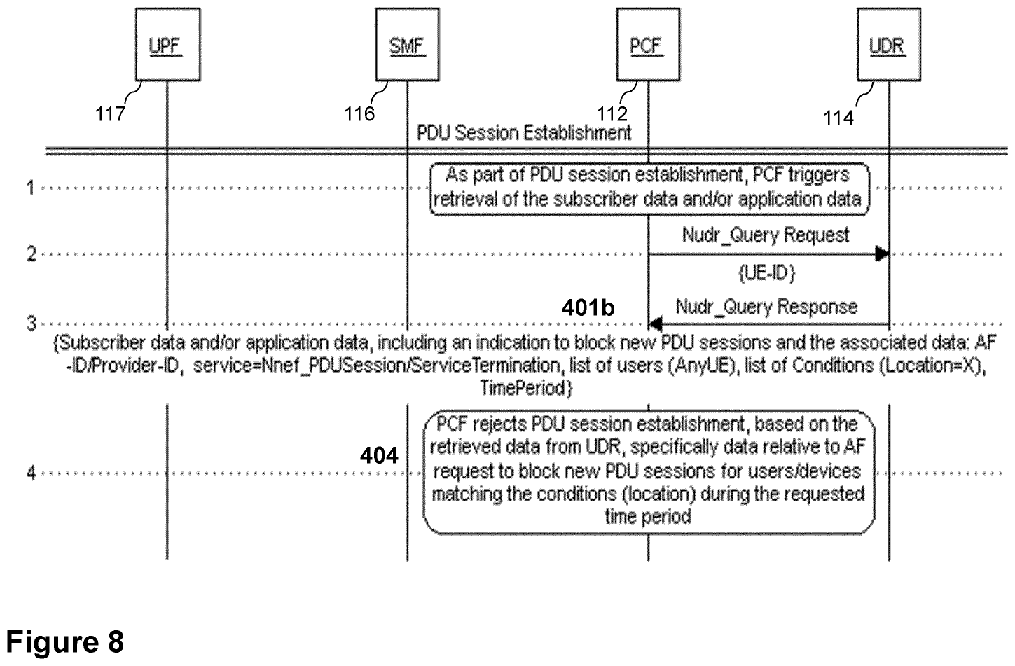

FIG. 8 is a signalling diagram depicting a second non-limiting example of embodiments herein illustrating a use case for a suspicion of a terrorist attack with a bomb for the case of new PDU sessions. The steps of this example are detailed below. In this non-limiting example, the second node 112 is a PCF and the fourth node 114 is a UDR. The communications system 100 also comprises a sixth node 116, in this example a Session Management Function (SMF), and a seventh node 117, which in this example is a UPF. At steps 1 and 2), as part of PDU session establishment, the second node 112 triggers retrieval of the subscriber data and/or application data for a subscriber by sending a Nudr_Query Request to the fourth node 114 at step 2, indicating e.g., a UE-ID. At step 3, the fourth node 114 returns the requested information in a Nudr_Query Response sent to the second node 112, which the second node 112 receives in agreement with Action 401b. The Nudr_Query Response comprises the subscriber data and/or application data, including an indication to block new PDU sessions and the associated data: AF-ID/Provider-ID, service=Nnef_PDUSession/Service Termination, list of users, e.g., AnyUE, list of Conditions, e.g., Location=X, and TimePeriod. At step 4, the second node 112, in accordance with Action 404, rejects PDU session establishment, based on the retrieved data from the fourth node 114, specifically data relative to the external node 113 request to block new PDU sessions for users and/or devices matching the conditions, e.g., location, during the requested time period.

It may be understood that embodiments herein do not only apply to 5G network architecture, but the same mechanisms may be applied to 4G, just by replacing: NEF by SCEF, PCF by PCRF, UDR by HSS, or a subscriber policy database, AMF by MME, SMF by Packet Gateway (PGW)-C or TDF-C, and/or UPF by PGW-U or TDF-U.

As a summarized overview of the foregoing, embodiments herein may be understood to be based on the definition of a new API, e.g., a Nnef Northbound API, for PDU Session/Service termination, which may be understood to allow the external node 113, e.g., an AF, to request a MNO through the first node 111, e.g., a NEF, to terminate ongoing PDU sessions, or services within the existing PDU sessions, and to block new PDU sessions for certain users and/or devices matching certain conditions, such as abnormal behavior, location, type of device to be blocked, roaming users affected only, etc, during a scheduled time period or permanently.

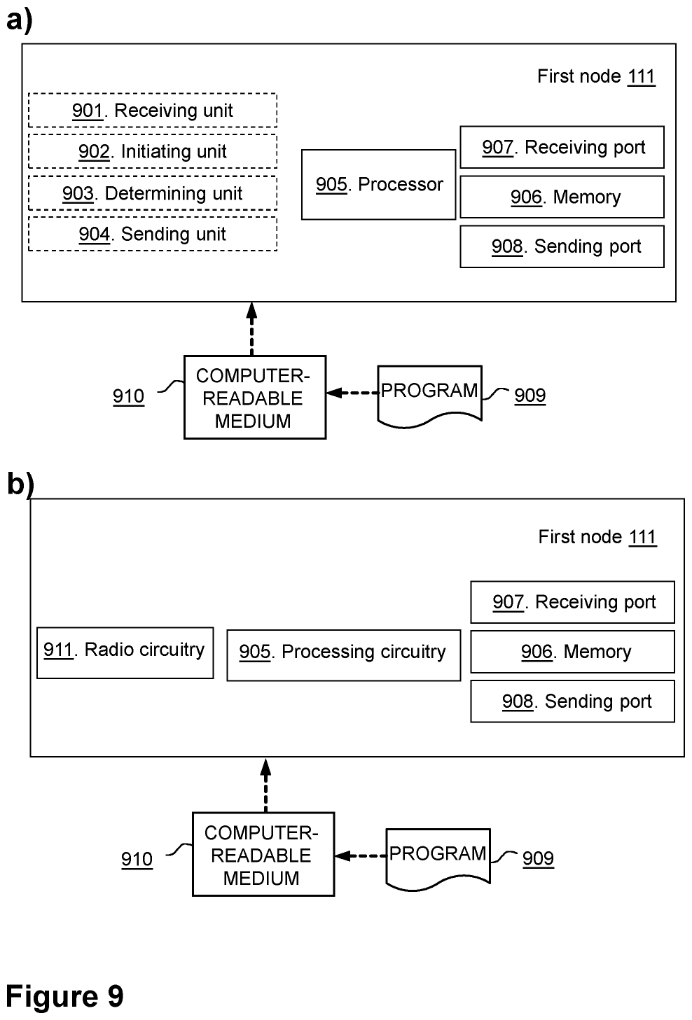

FIG. 9 depicts two different examples in panels a) and b), respectively, of the arrangement that the first node 111 may comprise to perform the method actions described above in relation to FIG. 3, and/or FIGS. 6-8. In some embodiments, the first node 111 may comprise the following arrangement depicted in FIG. 9a. The first node 111 may be understood to be for handling one or more data sessions. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the first node 111 and will thus not be repeated here. For example, the first node 111 may be configured to be a NEF, the external node 113 may be configured to be an AF, and the second node 112 may be configured to be a PCF.

The first node 111 is configured to, e.g. by means of a receiving unit 901 within the first node 111 configured to, receive, the first indication configured to originate from the external node 113 configured to operate outside the communications system 100. The first indication is configured to indicate the request to preclude the one or more data sessions meeting the one or more conditions configured to be indicated by the external node 113.

The first node 111 is also configured to, e.g. by means of an initiating unit 902 within the first node 111 configured to, initiate the preclusion of the one or more data sessions by sending the another indication to the second node 112 configured to operate in the communications system 100. The another indication is configured to indicate the request configured to be received.

In some embodiments, the request to preclude may be configured to indicate at least one of: a) to terminate any ongoing data sessions of the one or more data sessions and b) to block any new data sessions of the one or more data sessions.

In some embodiments, the first indication may be configured to indicate at least one of: a) the first identifier of the external node 113, b) the one or more respective second identifiers of one or more devices 130 configured to hold the ongoing data sessions to be terminated and/or to hold the new data sessions to be blocked, c) the one or more second indications of the one or more conditions, d) the third indication of one or more applications the request may be configured to apply to, e) the fourth indication of the one or more flows the request may be configured to apply to, and f) the fifth indication of the time period during which the request may be configured to apply.

In some embodiments, the one or more conditions may be configured to be indicated by at least one of: a) the third identifier of the location wherein the request may be configured to apply, b) the sixth indication of the first device 131 the location of which may be configured to determine the geographical area wherein the request may be configured to apply, c) the one or more respective seventh indications of the one or more data sessions, d) the eighth indication configured to indicate whether or not the request may be configured to apply only to devices roaming in the network configured to be managed by the communications system 100, e) the ninth indication of the provider to which the request may be configured to apply, the provider being configured to be of at least the subset of the one or more devices 130, f) the tenth indication of the one or more types of devices the request may be configured to apply to, and g) the eleventh indication of the one or more types of RAT the request may be configured to apply to.

In some embodiments, the first node 111 may be configured to, e.g. by means of a determining unit 903 within the first node 111 configured to, determine whether the external node 113 may be authorized for the request configured to be received.

In some embodiments, the first node 111 may be configured to, e.g. by means of a sending unit 904 within the first node 111 configured to, send the first response to the external node 113. The first response may be configured to indicate whether or not the request may be authorized. The sending of the another indication may be configured to be based on the response configured to be sent.

The first node 111 may be further configured to, e.g. by means of the sending unit 904 further configured to, send the request configured to be received to the fourth node 114 configured to operate in the communications system 100, thereby requesting the fourth node 114 to store the request configured to be received.

In some embodiments, the fourth node 114 may be configured to be a UDR.

The embodiments herein may be implemented through one or more processors, such as a processor 905 in the first node 111 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 906 comprising one or more memory units. The memory 906 is arranged to be used to store obtained information, store data, configurations, schedulings, and applications etc. to perform the methods herein when being executed in the first node 111.

In some embodiments, the first node 111 may receive information from, e.g., the second node 112, the external node 113, the fourth node 114, the fifth node 115, the sixth node 116, the seventh node 117, and/or the one or more devices 130 through a receiving port 907. In some examples, the receiving port 907 may be, for example, connected to one or more antennas in the first node 111. In other embodiments, the first node 111 may receive information from another structure in the communications system 100 through the receiving port 907. Since the receiving port 907 may be in communication with the processor 905, the receiving port 907 may then send the received information to the processor 905. The receiving port 907 may also be configured to receive other information.

The processor 905 in the first node 111 may be further configured to transmit or send information to e.g., the second node 112, the external node 113, the fourth node 114, the fifth node 115, the sixth node 116, the seventh node 117, the one or more devices 130 and/or another structure in the communications system 100, through a sending port 908, which may be in communication with the processor 905, and the memory 906.

Those skilled in the art will also appreciate that any of the units 901-904 described above may refer to a combination of analog and digital circuits, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-904 described above may be the processor 905 of the first node 111, or an application running on such processor.

Thus, the methods according to the embodiments described herein for the first node 111 may be respectively implemented by means of a computer program 909 product, comprising instructions, i.e., software code portions, which, when executed on at least one processor 905, cause the at least one processor 905 to carry out the actions described herein, as performed by the first node 111. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the first node 111. In some embodiments, the computer-readable storage medium 910 may be a non-transitory computer-readable storage medium, such as a CD ROM disc, a memory stick, or stored in the cloud space. In other embodiments, the computer program 909 product may be stored on a carrier containing the computer program, wherein the carrier is one of an electronic signal, optical signal, radio signal, or the computer-readable storage medium 910, as described above.

The first node 111 may comprise an interface unit to facilitate communications between the first node 111 and other nodes or devices, e.g., the second node 112, the external node 113, the fourth node 114, the fifth node 115, the sixth node 116, the seventh node 117, the one or more devices 130 and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 905, e.g., one or more processors such as the processor 905, in the first node 111 and the memory 906. The first node 111 may also comprise a radio circuitry 911, which may comprise e.g., the receiving port 907 and the sending port 908. The processing circuitry 905 may be configured to, or operable to, perform the method actions according to FIG. 3, and/or FIGS. 6-8, in a similar manner as that described in relation to FIG. 9a. The radio circuitry 911 may be configured to set up and maintain at least a wireless connection with the second node 112, the external node 113, the fourth node 114, the fifth node 115, the sixth node 116, the seventh node 117, the one or more devices 130 and/or another structure in the communications system 100.

Hence, embodiments herein also relate to the first node 111 operative for handling one or more data sessions, the first node 111 being operative to operate in the communications system 100. The first node 111 may comprise the processing circuitry 905 and the memory 906, said memory 906 containing instructions executable by said processing circuitry 905, whereby the first node 111 is further operative to perform the actions described herein in relation to the first node 111, e.g., in FIG. 3, and/or FIGS. 6-8.

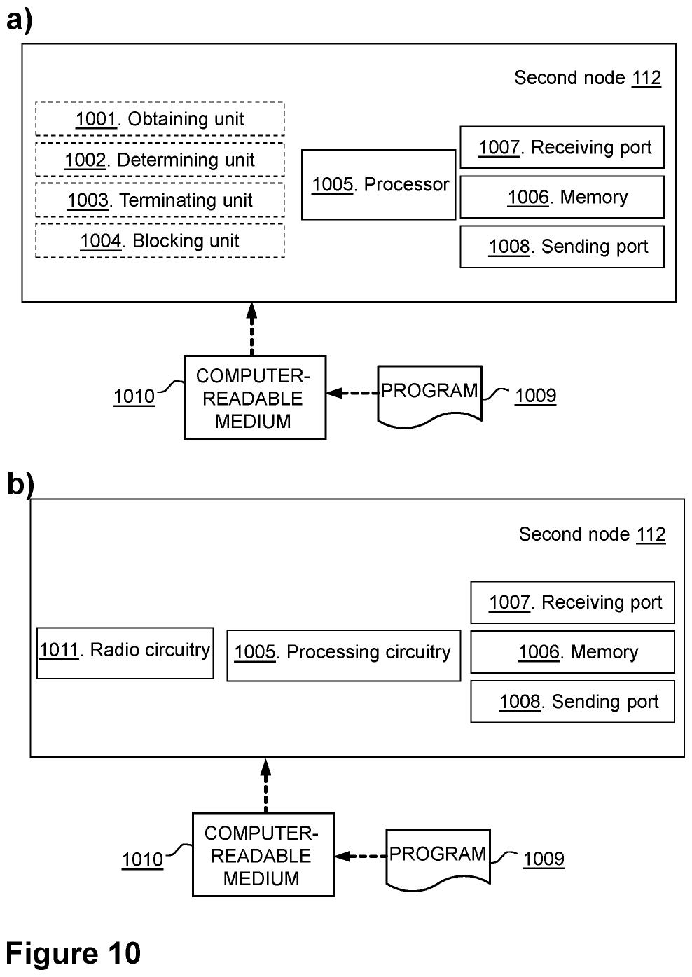

FIG. 10 depicts two different examples in panels a) and b), respectively, of the arrangement that the second node 112 may comprise to perform the method actions described above in relation to FIG. 4, and/or FIGS. 6-8. In some embodiments, the second node 112 may comprise the following arrangement depicted in FIG. 10a. The second node 112 may be understood to be for handling one or more data sessions. The second node 112 may be configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 10, optional boxes are indicated by dashed lines. The detailed description of some of the following corresponds to the same references provided above, in relation to the actions described for the second node 112 and will thus not be repeated here. For example, the second node 112 may be configured to be a PCF, and the another node 111, 114 may be configured to be one of: a NEF, and a UDR.

The second node 112 is configured to, e.g. by means of an obtaining unit 1001 within the second node 112 configured to, obtain, from the another node 111, 114 configured to operate in the communications system 100, the indication configured to indicate the request to preclude the one or more data sessions meeting the one or more conditions. The request is configured to be according to the service of the communications system 100 configured to be indicated.

In some embodiments, the request to preclude may be configured to indicate at least one of: a) to terminate any ongoing data sessions of the one or more data sessions of the one or more data sessions, and b) to block any new data sessions of the one or more data sessions.

In some embodiments, the indication may be configured to indicate at least one of: a) the first identifier of the external node 113 external to the communications system 100 from which the request to preclude is configured to originate, b) the one or more respective second identifiers of one or more devices 130 configured to hold the ongoing data sessions to be terminated and/or to hold the new data sessions to be blocked, c) the one or more second indications of the one or more conditions, d) the third indication of one or more applications the request may be configured to apply to, e) the fourth indication of the one or more flows the request may be configured to apply to, and f) the fifth indication of the time period during which the request may be configured to apply.

In some embodiments, the one or more conditions may be configured to be indicated by at least one of: a) the third identifier of the location wherein the request may be configured to apply, b) the sixth indication of the first device 131 the location of which may be configured to determine the geographical area wherein the request may be configured to apply, c) the one or more respective seventh indications of the one or more data sessions, d) the eighth indication configured to indicate whether or not the request may be configured to apply only to devices roaming in the network configured to be managed by the communications system 100, e) the ninth indication of the provider to which the request may be configured to apply, the provider being configured to be of at least the subset of the one or more devices 130, f) the tenth indication of the one or more types of devices the request may be configured to apply to, and g) the eleventh indication of the one or more types of RAT the request may be configured to apply to.

In some embodiments, the obtaining may be configured to comprise at least one of: a) to receive the another indication from the first node 111 configured to operate in the communications system 100; wherein the another indication may be configured to indicate the request to preclude the one or more data sessions meeting the one or more conditions, and b) to retrieve the another indication from the fourth node 114 configured to operate in the communications system 100.

The second node 112 may also be configured to, e.g. by means of a determining unit 1002 within the second node 112 configured to, determine the one or more data sessions meeting the one or more conditions, and thereby initiate the preclusion of the one or more data sessions.

The second node 112 may be further configured to, e.g. by means of a terminating unit 1003 within the second node 112 configured to, terminate any ongoing data sessions of the one or more data sessions configured to be determined.

The second node 112 may be further configured to, e.g. by means of a blocking unit 1004 within the second node 112 configured to, block any new data sessions of the one or more data sessions configured to be determined.

The embodiments herein may be implemented through one or more processors, such as a processor 1005 in the second node 112 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1006 comprising one or more memory units. The memory 1006 is arranged to be used to store obtained information, store data, configurations, schedulings, and applications etc. to perform the methods herein when being executed in the second node 112.

In some embodiments, the second node 112 may receive information from, e.g., the first node 111, the external node 113, the fourth node 114, the fifth node 115, the sixth node 116, the seventh node 117, and/or any of the one or more devices 130, through a receiving port 1007. In some examples, the receiving port 1007 may be, for example, connected to one or more antennas in the second node 112. In other embodiments, the second node 112 may receive information from another structure in the communications system 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the second node 112 may be further configured to transmit or send information to e.g., the first node 111, the external node 113, the fourth node 114, the fifth node 115, the sixth node 116, the seventh node 117, any of the one or more devices 130, and/or another structure in the communications system 100, through a sending port 1008, which may be in communication with the processor 1005, and the memory 1006.

Those skilled in the art will also appreciate that the units 1001-1004 described above may refer to a combination of analog and digital circuits, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1001-1004 described above may be the processor 1005 of the second node 112, or an application running on such processor.

Thus, the methods according to the embodiments described herein for the second node 112 may be respectively implemented by means of a computer program 1009 product, comprising instructions, i.e., software code portions, which, when executed on at least one processor 1005, cause the at least one processor 1005 to carry out the actions described herein, as performed by the second node 112. The computer program 1009 product may be stored on a computer-readable storage medium 1010. The computer-readable storage medium 1010, having stored thereon the computer program 1009, may comprise instructions which, when executed on at least one processor 1005, cause the at least one processor 1005 to carry out the actions described herein, as performed by the second node 112. In some embodiments, the computer-readable storage medium 1010 may be a non-transitory computer-readable storage medium, such as a CD ROM disc, a memory stick, or stored in the cloud space. In other embodiments, the computer program 1009 product may be stored on a carrier containing the computer program, wherein the carrier is one of an electronic signal, optical signal, radio signal, or the computer-readable storage medium 1010, as described above.

The second node 112 may comprise an interface unit to facilitate communications between the second node 112 and other nodes or devices, e.g., the first node 111, the external node 113, the fourth node 114, the fifth node 115, the sixth node 116, the seventh node 117, any of the one or more devices 130, and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 10b. The second node 112 may comprise a processing circuitry 1005, e.g., one or more processors such as the processor 1005, in the second node 112 and the memory 1006. The second node 112 may also comprise a radio circuitry 1011, which may comprise e.g., the receiving port 1007 and the sending port 1008. The processing circuitry 1005 may be configured to, or operable to, perform the method actions according to FIG. 4, and/or FIGS. 6-8, in a similar manner as that described in relation to FIG. 10a. The radio circuitry 1011 may be configured to set up and maintain at least a wireless connection with the first node 111, the external node 113, the fourth node 114, the fifth node 115, the sixth node 116, the seventh node 117, any of the one or more devices 130, and/or another structure in the communications system 100.

Hence, embodiments herein also relate to the second node 112 operative for handling one or more data sessions, the second node 112 being operative to operate in the communications system 100. The second node 112 may comprise the processing circuitry 1005 and the memory 1006, said memory 1006 containing instructions executable by said processing circuitry 1005, whereby the second node 112 is further operative to perform the actions described herein in relation to the second node 112, e.g., in FIG. 4, and/or FIGS. 6-8.

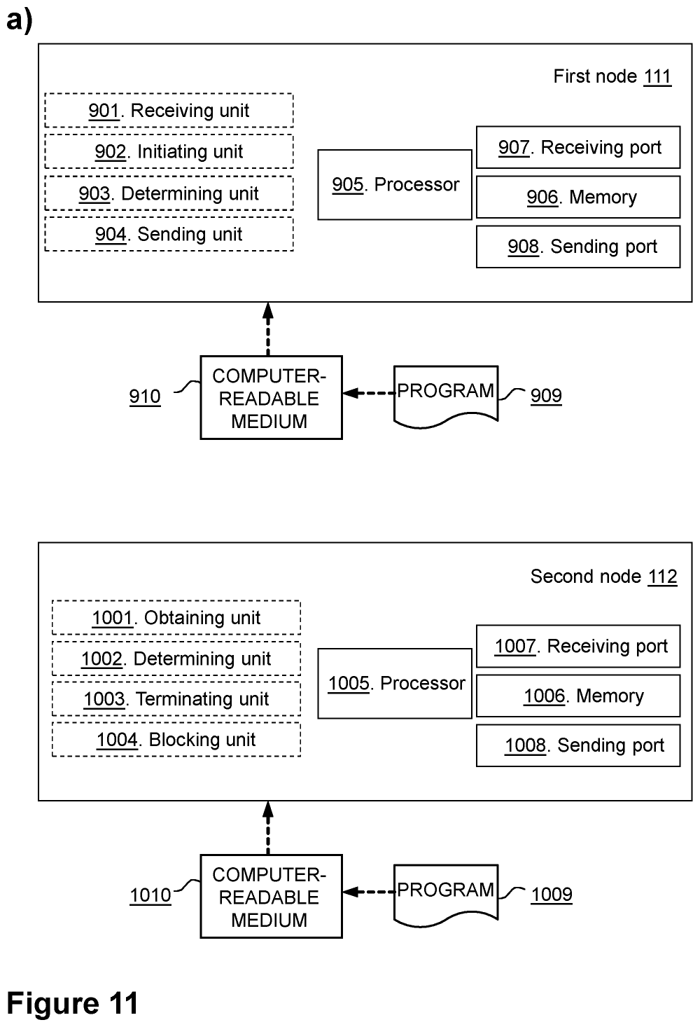

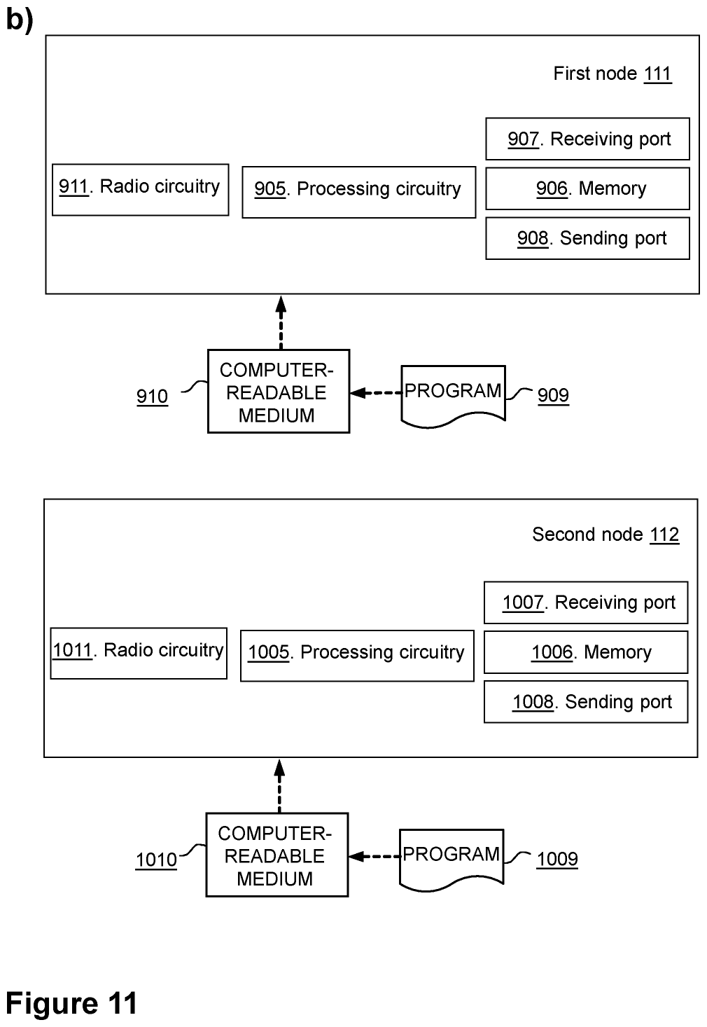

FIG. 11 depicts two different examples in panels a) and b), respectively, of the arrangement that the communications system 100 may comprise to perform the method actions described above in relation to FIG. 6. The arrangement depicted in panel a) corresponds to that described in relation to panel a) in FIG. 9 and FIG. 10 for each of the first node 111 and the second node 112, respectively. The arrangement depicted in panel b) corresponds to that described in relation to panel b) in FIG. 9 and FIG. 10 for each of the first node 111 and the second node 112, respectively. The communications system 100 may be for handling one or more data sessions. The communications system 100 comprises the first node 111 and the second node 112.

The communications system 100 is configured to, e.g. by means of the receiving unit 901 within the first node 111 configured to, receive, by the first node 111 configured to operate in the communications system 100, the first indication configured to originate from the external node 113 configured to operate outside the communications system 100. The first indication is configured to indicate the request to preclude the one or more data sessions meeting the one or more conditions configured to be indicated by the external node 113.

The communications system 100 is configured to, e.g. by means of the initiating unit 902 within the first node 111 configured to, initiate, by the first node 111, the preclusion of the one or more data sessions by sending the another indication to the second node 112 configured to operate in the communications system 100. The another indication is configured to indicate the request configured to be received.

The second node 112 is configured to, e.g. by means of the obtaining unit 1001 within the second node 112 configured to, obtain, by the second node 112, from the another node 111, 114 configured to operate in the communications system 100, the another indication being configured to indicate the request to preclude the one or more data sessions meeting the one or more conditions. The request is configured to be according to the service of the communications system 100 configured to be indicated.

The second node 112 may also be configured to, e.g. by means of the determining unit 1002 within the second node 112 configured to, determine, by the second node 112, the one or more data sessions meeting the one or more conditions, and thereby initiate the preclusion of the one or more data sessions.

In some embodiments, the request to preclude may be configured to indicate at least one of: a) to terminate any ongoing data sessions of the one or more data sessions and b) to block any new data sessions of the one or more data sessions.

In some embodiments, at least one of the first indication and the another indication may be configured to indicate at least one of: a) the first identifier of the external node 113, b) the one or more respective second identifiers of one or more devices 130 configured to hold the ongoing data sessions to be terminated and/or to hold the new data sessions to be blocked, c) the one or more second indications of the one or more conditions, d) the third indication of one or more applications the request may be configured to apply to, e) the fourth indication of the one or more flows the request may be configured to apply to, and f) the fifth indication of the time period during which the request may be configured to apply.

In some embodiments, the one or more conditions may be configured to be indicated by at least one of: a) the third identifier of the location wherein the request may be configured to apply, b) the sixth indication of the first device 131 the location of which may be configured to determine the geographical area wherein the request may be configured to apply, c) the one or more respective seventh indications of the one or more data sessions, d) the eighth indication configured to indicate whether or not the request may be configured to apply only to devices roaming in the network configured to be managed by the communications system 100, e) the ninth indication of the provider to which the request may be configured to apply, the provider being configured to be of at least the subset of the one or more devices 130, f) the tenth indication of the one or more types of devices the request may be configured to apply to, and g) the eleventh indication of the one or more types of RAT the request may be configured to apply to.

The communications system 100 may be configured to, e.g. by means of the determining unit 903 within the first node 111 configured to, determine, by the first node 111, whether the external node 113 may be authorized for the request configured to be received.

The communications system 100 may be configured to, e.g. by means of the sending unit 904 within the first node 111 configured to, send, by the first node 111, the first response to the external node 113, the first response being configured to indicate whether or not the request is authorized. The sending of the another indication may be configured to be based on the response configured to be sent.

The communications system 100 may be configured to, e.g. by means of the sending unit 904 further configured to, send, by the first node 111, the request configured to be received to the fourth node 114 configured to operate in the communications system 100, thereby requesting the fourth node 114 to store the request configured to be received.

In some embodiments, the fourth node 114 may be configured to be a UDR.

In some embodiments, the communications system 100 may be further configured to, e.g. by means of the terminating unit 1003 within the second node 112 configured to, terminate, by the second node 112, any ongoing data sessions of the one or more data sessions configured to be determined.

In some embodiments, the communications system 100 may be further configured to, e.g. by means of the blocking unit 1004 within the second node 112 configured to, block, by the second node 112, any new data sessions of the one or more data sessions configured to be determined.

In some embodiments, the obtaining may be configured to comprise at least one of: a) to receive, by the second node 112, the another indication from the first node 111 configured to operate in the communications system 100; the another indication may be configured to indicate the request to preclude the one or more data sessions meeting the one or more conditions, and b) to retrieve, by the second node 112, the another indication from the fourth node 114 configured to operate in the communications system 100.

In some embodiments, the first node 111 may be configured to be a NEF, the external node 113 may be configured to be an AF, the second node 112, may be configured to be a PCF, and the another node 111, 114 may be configured to be one of: the first node 111, and a UDR.

The remaining configurations described for the first node 111 and the second node 112 in relation to FIG. 11, may be understood to correspond to those described in FIG. 9 and FIG. 10, respectively, and to be performed, e.g., by means of the corresponding units and arrangements described in FIG. 9 and FIG. 10, which will not be repeated here.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### Reference

3GPP TS 29.522 V16.5.0 (September 2020) 5G System; Network Exposure Function Northbound APIs; Stage 3.

1-54. (canceled)

55. A method, performed by a first node, for handling one or more data sessions, the first node operating in a communications system, the method comprising:
receiving, a first indication originating from an external node operating outside the communications system, the first indication indicating a request to preclude one or more data sessions meeting one or more conditions indicated by the external node; and
initiating the preclusion of the one or more data sessions by sending another indication to a second node operating in the communications system, the another indication indicating the received request.

56. The method of claim 55, wherein the request to preclude indicates at least one of:
terminating any ongoing data sessions of the one or more data sessions; or blocking any new data sessions of the one or more data sessions.

57. The method of claim 55, wherein the first indication indicates at least one of:
a first identifier of the external node;
one or more respective second identifiers of one or more devices holding an ongoing data sessions to be terminated and/or to hold new data sessions to be blocked;
one or more second indications of the one or more conditions;
a third indication of one or more applications the request applies to;
a fourth indication of one or more flows the request applies to; and
a fifth indication of a time period during which the request applies.

58. The method of claim 55, wherein the one or more conditions are indicated by at least one of:
a third identifier of a location wherein the request applies;
a sixth indication of a first device the location of which determines a geographical area wherein the request applies;
one or more respective seventh indications of the one or more data sessions;
an eighth indication indicating whether or not the request applies only to devices roaming in a network managed by the communications system;
a ninth indication of a provider to which the request applies, the provider being of at least a subset of the one or more devices;
a tenth indication of one or more types of devices the request applies to; and
an eleventh indication of one or more types of Radio Access Technology (RAT) the request applies to.

59. The method of claim 55, further comprising:
determining whether the external node is authorized for the received request; and
sending a first response to the external node, the first response indicating whether or not the request is authorized;
wherein the sending of the another indication is based on the sent first response.

60. The method of claim 55, the method further comprising sending the received request to a fourth node operating in the communications system, thereby requesting the fourth node to store the received request.

61. The method of claim 60, wherein the fourth node is a Unified Data Repository, UDR.

62. The method of claim 55, wherein the first node is a Network Exposure Function (NEF), the external node is an Application Function (AF), and the second node, is a Policy Charging Function (PCF).

63. A first node, for handling one or more data sessions, the first node operating in a communications system, the first node comprising:
processing circuitry and memory, the memory containing instructions executable by the processing circuitry whereby the first node is operative to:
receive, a first indication originating from an external node operating outside the communications system, the first indication indicating a request to preclude one or more data sessions meeting one or more conditions indicated by the external node; and
initiate the preclusion of the one or more data sessions by sending another indication to a second node operating in the communications system, the another indication indicating the received request.

64. The first node of claim 63, wherein the request to preclude indicates at least one of: terminating any ongoing data sessions of the one or more data sessions; or blocking any new data sessions of the one or more data sessions.

65. The first node of claim 63, wherein the first indication indicates at least one of:
a first identifier of the external node;
one or more respective second identifiers of one or more devices holding an ongoing data sessions to be terminated and/or to hold new data sessions to be blocked;
one or more second indications of the one or more conditions;
a third indication of one or more applications the request applies to;
a fourth indication of one or more flows the request applies to; and
a fifth indication of a time period during which the request applies.

66. The first node of claim 63, wherein the one or more conditions are indicated by at least one of:
a third identifier of a location wherein the request applies;
a sixth indication of a first device the location of which determines a geographical area wherein the request applies;
one or more respective seventh indications of the one or more data sessions;
an eighth indication indicating whether or not the request applies only to devices roaming in a network managed by the communications system;
a ninth indication of a provider to which the request applies, the provider being of at least a subset of the one or more devices;
a tenth indication of one or more types of devices the request applies to; and
an eleventh indication of one or more types of Radio Access Technology (RAT) the request applies to.

67. The first node of claim 63, the first node further operative to:
determine whether the external node is authorized for the received request; and
send a first response to the external node, the first response indicating whether or not the request is authorized;
wherein the sending of the another indication is based on the sent first response.

68. The first node of claim 63, the first node further operative to send the received request to a fourth node operating in the communications system, thereby requesting the fourth node to store the received request.

69. The first node of claim 68, wherein the fourth node is a Unified Data Repository, UDR.

70. The method of claim 63, wherein the first node is a Network Exposure Function, NEF, the external node is an Application Function, AF, and the second node, is a Policy Charging Function, PCF.

71. A non-transitory computer-readable medium storing a computer program product for controlling a first node, the computer program product comprising software instructions that, when run on processing circuitry of the first node, cause the first node to:
receive, a first indication originating from an external node operating outside the communications system, the first indication indicating a request to preclude one or more data sessions meeting one or more conditions indicated by the external node; and
initiate the preclusion of the one or more data sessions by sending another indication to a second node operating in the communications system, the another indication indicating the received request.

72. The non-transitory computer-readable medium of claim 71, wherein the request to preclude indicates at least one of: terminating any ongoing data sessions of the one or more data sessions; or blocking any new data sessions of the one or more data sessions.

73. The non-transitory computer-readable medium of claim 71, wherein the first indication indicates at least one of:
a first identifier of the external node;
one or more respective second identifiers of one or more devices holding an ongoing data sessions to be terminated and/or to hold new data sessions to be blocked;
one or more second indications of the one or more conditions;
a third indication of one or more applications the request applies to;
a fourth indication of one or more flows the request applies to; and
a fifth indication of a time period during which the request applies.

74. A communications system, for handling one or more data sessions, the communications system comprising:
a first node configured to:
receive a first indication configured to originate from an external node configured to operate outside the communications system, the first indication being configured to indicate a request to preclude one or more data sessions meeting one or more conditions configured to be indicated by the external node; and
initiate the preclusion of the one or more data sessions by sending another indication to the second node configured to operate in the communications system, the another indication being configured to indicate the request configured to be received;
a second node configured to:
obtain from another node configured to operate in the communications system, the another indication being configured to indicate the request to preclude the one or more data sessions meeting the one or more conditions, the request being configured to be according to a service of the communications system configured to be indicated; and
determine the one or more data sessions meeting the one or more conditions, and thereby initiate the preclusion of the one or more data sessions.
